(19) United States
(12) Patent Application Publication
(10) Pub. No.: US 2006/0153247 A1
(43) Pub. Date: Jul. 13, 2006

(54) System and method for avoiding clipping in a communications system

(75) Inventor: Peggy Marie Stumer, Boca Raton, FL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and communication Networks, Inc., Boca Raton, FL (US)

(21) Appl. No.: 11/330,483

(22) Filed: Jan. 12, 2006

(30) Foreign Application Priority Data
Jan. 13, 2005 (GB) 0500606.9

(51) Int. Cl. H04J 3/06; H04J 3/16; H04J 3/22; H04L 12/66

(52) U.S. Cl. 370/517; 370/352; 370/465

(57) ABSTRACT

In a communication system, a buffer is provided at or between a transmitting device and a receiving device. When the transmitting device is unable to send a stream of media packets or the receiving device is unable to render the stream of media packets, the buffer stores the media packets, and the size of the buffer is reduced when the transmitting device is able to send the stream of media packets and/or the receiving device is able to render the stream of packets.

### CROSS-REFERENCE TO RELATED APPLICATION

This application claims priority to Great Britain Patent Application 0500606.9 entitled “Method of Eliminating Real-Time Data Loss on Establishing a Call” filed on Jan. 13, 2005.

### BACKGROUND OF THE INVENTION

1. Field of the Invention

The present invention relates to clipping avoidance in a communications environment. More particularly, the present invention relates to utilizing a buffer to store packets of data so that the data may be rendered at a slightly later time e.g., when the user media stream is completely established. 2. Description of the Related Art

When establishing a telephone or multi-media call over a packet network such as a network using the Internet Protocol (IP), there can be a delay in establishing the packet streams for audio data and other real-time media data. This can lead to the loss of data at the establishment of the call or call segment. This can be particularly apparent and inconvenient for audio data in the direction called party to calling party (backward direction), since the initial greeting can be wholly or partially lost.

When the called party answers, the called device (e.g. telephone) sends a signal through the network to indicate that answer has occurred and also begins transmitting audio packets. Traditionally the called party begins to speak as soon as the call is answered (e.g., after lifting the handset or pressing a button), so it would be beneficial for the transmission of audio packets begin quickly when answer occurs. Furthermore, it would be beneficial for the device associated with the calling party (calling device) to be in a position to receive these packets and render their audio contents to the user as soon as they arrive. Thus, in an ideal system (that the present art has trouble achieving for at least the reasons described in the next several paragraphs) the calling device begins transmitting audio packets in the forward direction sufficiently early in the call to prevent loss of speech and the called device is in a position to receive these packets and quickly render them to the called user.

Unfortunately there are several reasons why transmitting packets or receiving and rendering packets cannot happen immediately. The precise reasons depend on the signalling protocol used to establish the call, e.g., the Session Initiation Protocol (SIP) (IETF RFC 3261) or ITU-T Recommendation H.323. However, the underlying reasons cannot be solved by choice of signalling protocol. The reasons listed below apply to delays in establishing the backward audio stream, but similar considerations can lead to delays in establishing the forward audio stream and likewise streams for other media.

Typically packets containing signalling such as the “signal indicating answer” take an indirect route through the network, passing through one or more devices known as proxies (SIP) or gatekeepers (H.323). On the other hand, audio packets typically take a direct route from the called device to the calling device to avoid any unwanted delay, which can have a negative impact on the quality of the conversation. Therefore the first audio packets are likely to arrive before the answer signal. The answer signal may contain information needed by the calling device to identify the backward stream of audio packets, and the calling device may be unable or unwilling (for security reasons) to accept and render received audio packets until the answer message arrives.

In some cases the calling device, even if it is able to identify the backward stream of audio packets, might require information in the answer signal in order to render that audio stream to the user. For example, if the audio data is encrypted, the calling device may need to await a key in the answer signal in order to decrypt the audio data.

Sometimes an intermediate device such as a SIP proxy may fork the call request from the calling device to several called devices. This can result in several called devices alerting the user and answer can occur on any of these devices. If answer occurs on two or more devices at approximately the same time, the devices concerned may begin transmitting backward audio and the calling device will receive two or more separate backward audio streams. On receiving two or more separate answer signals, the proxy or calling device may arbitrate by retaining the call to one of the devices (normally the one from which the first answer signal is received) and cancel the remaining call. Until the answer signal arrives, the calling device may not be in a position to select the correct backward audio stream and render the received packets in that stream.

Sometimes an intermediate device can fork the call request as described above, where one of the destinations is via a gateway to a circuit-switched network (e.g., the public switched telephony network). The gateway may transmit a backward audio stream prior to answer so that tones or announcements from the circuit-switched network can be rendered to the calling user. If several forked-to destinations result in this behaviour, the calling device must choose a single backward audio stream to render to the user (usually the first received). However, if answer occurs at one of the other forked-to destinations (whether or not that destination is reached via a gateway), delays in receiving the answer signal and switching to the appropriate backward audio stream can cause loss of important audio data.

The above scenarios usually affect a receiving device's ability to render a stream. Another scenario usually affects a transmitting device, wherein the transmitting device, e.g., a called device, may not have sufficient information at the time of answer to start transmitting audio packets to the calling device. The information concerned may include, e.g., the IP address of the calling device, the port number on the calling device, the audio codec supported by the calling device and the encryption key to be used. There are various complex call scenarios where this can occur, one example being where a device “picks up” a call that has been alerting the user at another device (e.g., within a small community of devices, or group pick-up). The result is the loss of audio data until the called device has obtained the necessary information.

There can be situations where a real-time medium (e.g., audio) can be transmitted over an Internet Protocol (IP) network via an intermediate entity, which introduces delays due to coding/decoding, packetisation and jitter absorption as well as any internal processing. This is often unavoidable because of the value added by the intermediate entities (eg., conference bridging, transcoding). However, if during a communication the intermediate entity is no longer required, it can be desirable to switch to a direct path for real-time media to eliminate the extra delay. One example is when an audio or multi-media conference reduces from 3 to 2 parties. If there is no immediate likelihood of adding further parties to the conference, policy may be to release the conference bridge resource, which would also reduce the delay between the two endpoints for real-time media. A further example is where a call has been established through legacy circuit-switches but the endpoints concerned are both IP-enabled, thereby allowing the possibility of real-time media to be routed directly between the endpoints. The call is established hop-by-hop through the circuit switches in the traditional manner. When it is determined that the destination is a second IP-enabled endpoint, the real-time media can be rerouted to take a direct path through the IP network, eliminating the circuit switches. Although in some cases it may be possible to do this before the call is answered, in other situations (e.g., where the call is broadcast to a number of endpoints, any one of which can answer), rerouting is not possible until after answer.

Unfortunately the process of rerouting real-time media streams during a call can introduce some discontinuity in the real-time media received at each endpoint. For example, this discontinuity can affect audio, but may also affect other types of communication, e.g., video.

Taking audio as an example, a number of factors may contribute to discontinuity. Often the delay difference between an original (indirect) path and a new (direct) path is such that packets will be received on the new path before the last packets have been received on the old path. Simply discarding any outstanding packets on the old path will lead to a discontinuity in the form of lost audio samples, perhaps resulting in the loss of entire syllables or words. The alternative of discarding packets on the new path until all packets on the old path have been received will likewise lead to lost audio samples, and this technique also introduces the problem of detecting when the last packet has been received on the old path. Yet another solution is to play all packets received on the old stream and buffer packets received on the new stream for play later, but as presently implemented this technique just maintains the delay inherent in the old path and fails to exploit the reduced delay on the new path. Reducing the delay would create an improved user perception, including a reduced likelihood of noticeable echo that has failed to be cancelled by the usual echo cancelling techniques.

### SUMMARY OF THE INVENTION

It is an object of the invention to provide a system and method that utilizes a buffer to store packets and subsequently reduces the size of the buffer at a time when at least some of the packets in the buffer can be rendered.

It is another object of the invention to provide a system and method that avoids speech clipping by storing audio stream packets in a buffer and processing the packets to gradually reduce the delay in real-time communication.

It is another object of the invention to provide a system and method to render data in a real-time data stream by introducing a buffer that allows the stored data to be rendered at a later time.

It is another object of the invention to provide a system and method to decrease the size of a buffer containing data in order to absorb a delay in the rendering of a data stream by waiting until the useful information in the data stream is substantially reduced (e.g., a pause by a speaker) before rendering information in the buffer.

It is another object of the invention to provide a system and method to gradually decrease the size of a buffer containing data in order to absorb a delay in the rendering of a data stream by dropping a small number (e.g., one) of packets in the data stream at a time.

The present invention utilizes a communication system comprising a first device connected remotely to a second device where data is sent in packets between the devices. The devices may be, for example, telephones or multimedia devices that can process audio and video data. The invention provides a system and method to avoid or reduce clipping by providing a buffer between or at the devices. In the event that the receiving device is unable to render a stream of packets sent from transmitting device, packets in the data stream are stored in a buffer, and when the receiving device can render the stream the size of the buffer is reduced. In the event that the transmitting device is unable to transmit a stream of packets, packets are stored in a buffer and when the transmitting device is able to transmit, the size of the buffer is reduced.

The invention thus involves buffering data and processing it later. This introduces an unwanted delay between the called user speaking and the calling user hearing the information, and this delay is gradually eliminated during the early part of the call.

The size of the buffer may be reduced by dropping packets. In a preferred embodiment the reduction of the size of the buffer is accomplished by dropping a small number (e.g., one) of packets at a time over a period of time while useful information is still being conveyed in a real-time stream. In an alternative preferred embodiment, a larger number of packets can be dropped: e.g., with audio data the dropped packets are preferably those associated with periods of silence, and with video data the dropped packets are associated with periods of little or no motion. In yet another preferred embodiment these two techniques are combined, so that the size of the buffer (and therefore the delay) can be more quickly reduced than one technique alone in those instances where there is a combination of useful information and pauses (or in the case of video, little or no motion). The rate at which packets are dropped may be varied, and may even be altered according to preferences (e.g., a user may wish to reduce delay quickly at the cost of reduced audio/video quality, while another user may wish to experience higher quality reception while allowing the delay to decrease more gradually).

Reducing the size of the buffer may alternatively comprise speech compression techniques. This may be necessary where bandwidth and/or buffer size is limited.

### BRIEF DESCRIPTION OF THE DRAWING

FIG. 1 is a diagram representing an example of two devices connected by a signalling network and a packet network according to a preferred embodiment of the invention.

FIG. 2 is a diagram representing an example of numerous devices connected by a signalling network wherein pairs of devices are connected by packet networks according to preferred embodiments of the invention.

### DETAILED DESCRIPTION

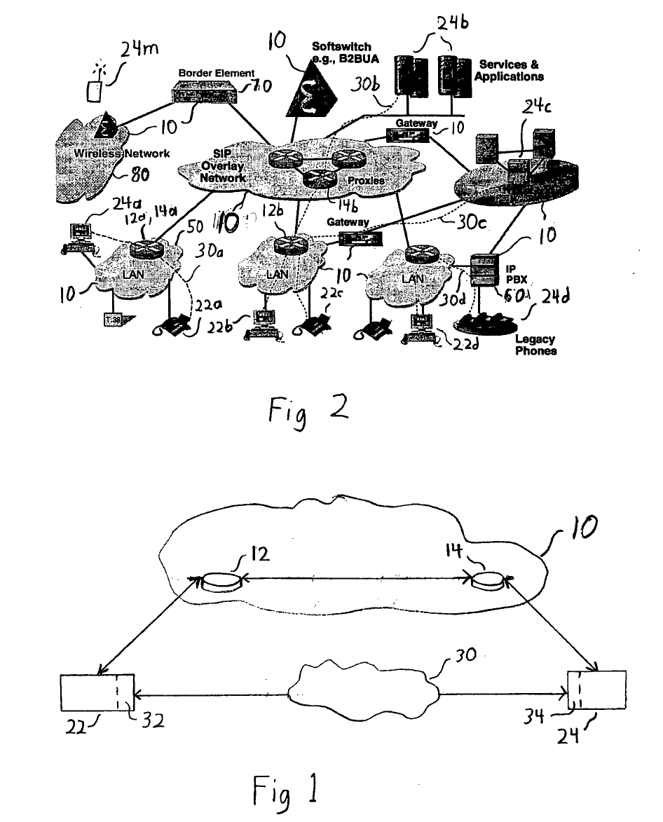

With reference to FIG. 1, signalling network 10 is shown. In a preferred embodiment, signalling network 10 comprises signalling proxy 12 and signalling proxy 14.

Calling device 22, which may be, for example, a voice over IP (VoIP) telephone, is used by a first user wishing to make a call to a second user at called device 24, which may be, for example, another VoIP telephone. The first user provides calling device 22 with information to reach the second user at device 24, for example a telephone number. Calling device 22 alerts signalling proxy 12, which sends a signal to signalling proxy 14. Signalling proxy 14 causes an alert (e.g., a ringing tone) to emit from called device 24. The second user picks up (e.g. picks up a handset at called device 24) and starts speaking.

In a first scenario, called device 24 has enough information to start sending data packets, which for the purpose of illustration is audio packets, through packet network 30. In a preferred embodiment, signalling network 10 and packet network 30 are different paths on the same network which may be, for example, the Internet. The packets are received at calling device 22, but cannot be rendered for some reason, for example because the packets are encrypted. Buffer 32, which is capable of storing several seconds of speech in a preferred embodiment, at calling device 22 stores the packets. In the meantime, called device 24 sends through signalling network 22 signalling information back to calling device 22, which signalling information may include, for example, a decryption key. Calling device 22 processes the returned signalling information and if the data is encrypted, starts decrypting the packets stored in buffer 32. Thus, the first user is able to hear the first syllables spoken by the second user, which were stored in buffer 32. The two users continue a conversation with an initial delay. As time goes on, buffer 32 is reduced in size, for example by occasionally dropping packets during the conversation and/or dropping chunks of packets during pauses in the conversation. In a preferred embodiment, the buffer size is reduced to substantially zero in a few seconds, though the time this takes may depend on, for example, pauses in the conversation and/or settings for buffer 32 that determine the rate at which packets are dropped.

In a second scenario, at the time of pick-up at called device 24, called device 24 does not have enough information to start sending data packets. Instead, the packets are stored at buffer 34, which is capable of storing several seconds of speech in a preferred embodiment. In the meantime, additional signalling information is provided through signalling proxy 14, which called device 24 processes until it is able to start streaming data packets through packet network 30. However, the packets in buffer 34 are sent first so that the first user at calling device 22 is able to hear the first syllables spoken by the second user. The two users continue a conversation with an initial delay. As time goes on, buffer 34 is reduced in size, for example by occasionally dropping packets during the conversation and/or dropping chunks of packets during pauses in the conversation. In a preferred embodiment, the buffer size is reduced to substantially zero in a few seconds, though the time this takes may depend on, for example, pauses in the conversation and/or settings for buffer 34 that determine the rate at which packets are dropped.

Thus, if the first scenario involves an audio stream, at calling device 22, if a backward audio stream starts to arrive before the device 22 is able to render it to the first user, buffers 32 buffers the packets concerned. Most VoIP telephones will already have what is known as a jitter buffer for absorbing variations in inter-packet arrival times, so buffer 32 may be this jitter buffer effectively increased in size to accommodate packets that cannot be quickly rendered. When it becomes known that the stream should be rendered to the user, the device begins to render the information from the buffer. However, because further packets will arrive as fast as the initial buffered packets are rendered to the user, the buffer will remain at approximately the same size and thereby impose a permanent and perhaps excessive delay on the backward audio stream. This delay can then be absorbed gradually, for example by dropping a packet at a time (dropping a single packet has negligible impact on speech quality, depending on codec involved), by waiting for a period of silence and dropping packets, or by speech compression techniques (where bandwidth and/or buffer size are limited) or by combinations of these methods and others. Thus over a period of perhaps a few seconds the delay is reduced to the optimum value for the new path and the buffer size can be reduced.

Revisiting the second scenario and assuming the stream is an audio stream, at called device 24, if it is not in a position to transmit the backward audio stream at the time of answer, it buffers the audio data in buffer 34. When it is able to start transmission, it begins to transmit information from buffer 34. However, because further packets are created as fast as packets are transmitted, buffer 34 remains at approximately the same size and thereby impose a delay on the backward audio stream. This delay is absorbed gradually either by dropping a packet at a time, by waiting for a period of silence and dropping packets, or by speech compression techniques (where bandwidth and/or buffer size are limited) or by combinations of these methods. Thus over a period of perhaps a few seconds the delay is reduced to the optimum value for the new path and the buffer size can be reduced.

As mentioned in the background section there are instances where calls or transmissions are re-routed and there may for a short time two or more paths from which data packets are received. In other words, the receiving device is unable to render said packets because it receives data packet streams from at least two corresponding different paths as a result of re-routing during a transmission/call. For this third scenario, in a preferred embodiment of the invention, a receiving endpoint (for example at calling device 22) first calculates the delay difference between the two paths. Then the endpoint increases its dynamic buffer size (for example, at buffer 32) by an amount equivalent to the calculated delay difference, so that it can accommodate extra packets due to concurrent arrival from the two paths. All packets from the old path are placed ahead of packets on the new path. In this way, packets are not lost, but a delay is introduced. As with other scenarios according to the present invention this delay is absorbed gradually either by dropping a packet at a time, by waiting for a period of silence and dropping packets, or by speech compression techniques (where bandwidth and/or buffer size are limited) or by combinations of these methods. Thus over a period of perhaps a few seconds the delay is reduced to the optimum value for the new path and the buffer size can be reduced.

With reference to FIG. 2, a network is shown wherein signalling network 10 is a SIP overlay network and may comprise elements such as a wireless network, softswitch, gateways, IP/PBX servers, PSTN/ISDN servers, a border elements, local area networks (LANs), etc. and interconnects endpoint devices, which may comprise, for example, SIP phones, servers, soft clients with video and fax capabilities, services and applications (which may reside on servers), mobile devices (such as mobile telephones), legacy telephones, etc. Examples of media packets/streams path through these networks, 30a, 30b, 30c, and 30d, are shown and described below, and may be established utilizing the procedure described above with respect to packet network 30 in FIG. 1. In this illustration, the signalling network 10 and media packet networks 30a, 30b, 30c, and 30d use the same physical transmission networks but take different paths through the networks.

In one example illustrated in FIG. 2, calling device 22a, which is a SIP phone, and called device 24a, which is a soft client residing on a desktop computer, establish a call via a LAN 50 that comprises a proxy 12a supporting both devices 22a, 24a, respectively. Once the call is established, packet network 30ais formed over the same LAN 50. In another illustrated example, a call is established between calling device 22b and called device 24b, which is a group of services and applications, utilizing proxy 12b and 14b, prior to forming packet network 30b. In yet another illustrated example, packet network 30c is formed between calling device 22c and called device 24c, which is a PSTN/ISDN server. In a final illustration, packet network 30d is formed between calling device 22d and called device 24d, which is a legacy telephone. In this last illustration, packets actually travel to and from calling device 22d and IP/PBX server with Gateway 60, which converts the packets to support legacy telephone 24d.

Although not shown in FIG. 2, in a preferred embodiment buffers typically reside at the endpoint devices. For example, calling device 22b includes a buffer, as does called device 24b. However, sometimes it is necessary or preferable to have buffers elsewhere in the network. For example, in network 30d, there is a buffer (not shown) in IP/PBX server 60 to support legacy telephone 24d. Similarly, border element 70 contains buffers (not shown) to support the mobile devices, such as mobile device 24m, in communication with wireless network 80.

It is to be appreciated that in the above descriptions of various embodiments of the invention, reducing the size of a buffer may entail merely reducing the size of the buffer being utilized, for example when the buffer has a static size (e.g., a pre-determined amount of random access memory). It is also to be appreciated that the buffer may reside at or near the receiving device (which is a preferred embodiment where the receiving device is likely to experience a delay is rendering data streams), at or near the transmitting device (which is a preferred embodiment where the transmitting device is likely to experience a delay in transmitting streams), or (in an alternative preferred embodiment) elsewhere in the communications system. More than one buffer may be utilized. For example, two buffers may be used when both the transmitting device and the receiving device may experience delays.

While the invention has been described in terms of preferred embodiments, those skilled in the art will recognize that the invention can be practiced with modification within the spirit and scope of the appended claims.

1. A method of eliminating or reducing clipping in a communication system comprising a transmitting device connected remotely to a receiving device where media data is sent in packets from said transmitting device to said receiving device comprising the steps of:
a) providing a buffer at said receiving device, or between said transmitting device and said receiving device;
b) detecting that the receiving device is unable to render a stream of media packets sent from said transmitting device;
c) storing media packets from said stream of media packets in said buffer; and
d) reducing the size of said buffer when said receiving device is able to render said stream until buffer is substantially empty.

2. The method of claim 1, wherein said buffer is part of said receiving device.

3. The method of claim 1, wherein at least one of said transmitting device and said receiving device is a mobile telephone and/or Session Initiation Protocol (SIP) workpoint.

4. The method of claim 1, wherein said stream of media packets comprises multimedia data.

5. The method of claim 1, wherein said reducing the size of said buffer further comprises the steps of:
d1) waiting until said stream of packets contains packets associated with silence or substantially little movement; and
d2) dropping said packets associated with silence or substantially little movement.

6. The method of claim 1, wherein said reducing the size of said buffer further comprises dropping a small number of packets at a time while said stream of packets contains packets associated with speech or motion.

7. The method of claim 6, wherein the rate at which said small number of packets is dropped is adjustable according to preferences.

8. A method of eliminating or reducing clipping in a communication system comprising a transmitting device connected remotely to a receiving device where media data is sent in packets from said transmitting device to said receiving device comprising the steps of:
a) providing a buffer at said transmitting device, or between said transmitting device and said receiving device;
b) detecting that the transmitting device is unable to send a stream of media packets to said receiving device;
c) storing media packets from said stream of media packets in said buffer; and
d) reducing the size of said buffer when said transmitting device is able to send a stream of packets to said receiving device until said buffer is substantially empty.

9. The method of claim 8, wherein said buffer is part of said transmitting device.

10. The method of claim 8, wherein at least one of said transmitting device and said receiving device is a mobile telephone.

11. The method of claim 8, wherein said stream of packets contains multimedia data.

12. A network comprising:
a) a receiving device logically connected to a transmitting device via signaling data; and
b) at least one buffer at said receiving device or between said transmitting device and said receiving device, wherein said at least one buffer contains a group of packets of media data from said transmitting device that cannot be immediately rendered at said receiving device, and wherein the size of said at least one buffer is reduced after said receiving device is able to render said group of packets of media data, until said at least one buffer is substantially empty.

13. The network of claim 12, wherein at least one of said at least one buffer is also a jitter buffer.

14. The network of claim 12, wherein said media data is multimedia data.

15. The network of claim 12, wherein at least one of said transmitting device and said receiving device is a mobile telephone and/or Session Initiation Protocol (SIP) workpoint.

16. The network of claim 12, wherein at least one of said at least one buffer is part of said receiving device.

17. A network comprising:
a) a transmitting device logically connected to a receiving device via signaling data; and
b) at least one buffer at said transmitting device or between said transmitting device and said receiving device, wherein said at least one buffer contains a group of packets of media data from said transmitting device that cannot be immediately streamed to said receiving device, and wherein the size of said at least one buffer is reduced after a media data stream from said transmitting device to said receiving device is established, until said at least one buffer is substantially empty.

18. The network of claim 17, wherein said media data is multimedia data.

19. The network of claim 17, wherein at least one of said transmitting device and said receiving device is a mobile telephone.

20. The network of claim 17, wherein at least one of said at least one buffer is part of said transmitting device.
